(19) United States
(12) Patent Application Publication
(10) Pub. No.: US 2025/0333584 A1
(43) Pub. Date: Oct. 30, 2025

(54) TYRE FOR VEHICLE WHEELS

(71) Applicant: PIRELLI TYRE S.P.A., Milano (IT)

(72) Inventors: Francesco ROMANI, Milano (IT); Francesca BAIONE, Milano (IT); John Nazareno HOUSE, Milano (IT); Marco MÖSENEDER FRAJRIA, Milano (IT)

(21) Appl. No.: 18/866,504

(22) PCT Filed: May 18, 2023
(86) PCT No.: PCT/IB2023/055108

§ 371 Date: Nov. 15, 2024

(30) Foreign Application Priority Data
May 20, 2022 (IT) 102022000010532

(51) Int. Cl. C08L 9/06; B60C 1/00; C08K 3/04; C08K 3/06; C08K 3/22; C08K 3/36; C08K 5/09; C08K 5/18; C08K 5/47; C08K 5/58

(52) U.S. Cl. CPC C08L 9/06; B60C 1/0016; B60C 1/0025; C08K 3/04; C08K 3/06; C08K 3/36; C08K 5/09; C08K 5/18; C08K 5/47; C08K 5/58; C08K 2003/2296; C08L 2205/035

(57) ABSTRACT

A tyre and related vulcanisable elastomeric compound and elastomeric composition are described. The tyre includes at least one structural element that includes a vulcanised elastomeric material including, before vulcanisation, a vulcanisable elastomeric compound including, before mixing, an elastomeric composition including per 100 phr of diene elastomeric polymer:
(a) 30 to 95 phr of at least one styrene-butadiene polymer (SBR);
(b) 5 to 70 phr of at least one diene elastomeric polymer selected from the group consisting of at least one isoprene polymer (IR), at least one butadiene polymer (BR), or mixtures thereof;
(c) 10 phr to about 120 phr, preferably 20 phr to 100 phr, of at least one white reinforcing filler;
(d) from about 1% to about 20% by weight, relative to the amount of said white reinforcing filler, of at least one silane coupling agent;
(e) 1% to 35% by weight, preferably 5% to 25% by weight, relative to the amount of said silane coupling agent, of a polyamine.

### FIELD OF THE INVENTION

The present invention relates to a tyre for vehicle wheels comprising a vulcanised elastomeric material obtained by vulcanisation of a vulcanisable elastomeric compound made by mixing an elastomeric composition comprising at least one diene elastomeric polymer, silica as reinforcing filler and at least one silane coupling agent, characterized by the incorporation of a polyamine capable of improving the vulcanisation kinetics and the performance of the tyre, in particular the balance between rolling resistance, abrasion resistance and mechanical properties.

### BACKGROUND ART

In the tyre industry, vulcanisation is a process commonly used to impart the necessary mechanical properties to the elastomeric compositions of the tyre components. This process influences the static and dynamic modules as well as the hysteresis of the elastomeric compositions at different temperatures and, consequently, the behaviour of the tyre on dry or wet surfaces as well as the rolling resistance and resistance to tearing and abrasion of the same during use.

The vulcanisation process typically uses sulphur to promote the cross-linking of the elastomeric composition, reinforced, for example with carbon black, to improve the mechanical features of the finished product.

However, the use of large amounts of sulphur can cause considerable reversion phenomena, which result in the modification of tyre performance during use, while the use of large amounts of carbon black provides pronounced hysteresis properties, i.e., an increase in heat dissipated under dynamic conditions, which results in an increase in the rolling resistance of the tyre and fuel consumption.

To overcome the drawbacks caused by the use of carbon black, so-called white reinforcing fillers may be used, in particular silica, as a total or partial replacement of carbon black.

However, although the use of said white reinforcing fillers leads to a lower hysteresis with consequent lower rolling resistance, it also implies a reduction of the mechanical properties, in particular the tear resistance, substantially due to the poor affinity of these fillers compared to elastomeric polymers commonly used in the production of tyres.

In particular, to obtain a good degree of dispersion of the silica in the elastomeric polymers it is necessary to subject the elastomeric compositions to a prolonged thermo-mechanical mixing action (“silicification” process), and to increase the affinity of the silica with the elastomeric polymers, it is necessary to use suitable coupling agents, such as, for example, organosilane products containing sulphur (“silanisation” process).

However, the need to use such coupling agents places a limit on the maximum temperature that can be reached during mixing and thermomechanical processing operations of the elastomeric compositions, to avoid irreversible thermal degradation of the coupling agents.

In order to overcome the above drawbacks, the introduction of other compounds able to promote the reaction of the silica with the coupling agent, thus improving the interaction with the elastomeric polymers, has been suggested in the prior art, as described for example in WO2021/014394, EP2193036 and EP2231759 in the name of the Applicant.

Although the solutions proposed in the art have brought improvements, the tyre industry has shown a continuous interest in finding new solutions suitable for obtaining optimal performance in terms of mechanical properties and hysteresis, while maintaining good stability, workability and vulcanisation kinetics of the elastomeric composition.

### SUMMARY OF THE INVENTION

The Applicant has undertaken studies to further improve the effectiveness of coupling agents in the production of compounds for tyres, with the aim of obtaining a better balancing of the vulcanisation curve by obtaining good hysteresis values without affecting the mechanical properties of the vulcanisation product, i.e. of the vulcanised elastomeric material.

Surprisingly, the Applicant has found that through the use of a polyamine in an elastomeric composition comprising at least one diene elastomeric polymer, silica as a reinforcing filler, and at least one silane coupling agent, it is possible to modulate the final properties of the vulcanised elastomeric material according to the required performances.

In particular, the Applicant has observed that the presence of the polyamine was able to simultaneously improve the static mechanical properties, in particular the elongation moduli and resistance to tearing, and the dynamic mechanical properties, in particular by reducing the tanδ values at high temperatures, with a significant reduction in hysteresis and rolling resistance, and maintaining adequate tanδ values at low temperatures, with consequent maintenance of good grip even on wet surfaces and at low temperatures.

At the same time, the Applicant has observed a higher value of the silanisation yield, which can allow a reduction in the amount of coupling agent and consequently a more stable system, in particular when the coupling agent is a sulpho-silane, since sulpho-silane could act as a sulphur donor and trigger vulcanisation.

Furthermore, the Applicant has verified that the vulcanisation curve is considerably influenced by the presence of the polyamine.

In particular, the Applicant has observed that by increasing the percentage of polyamine the vulcanisation curve varies from the typical shape with an incremental modulus to a shape comprising modulus values which reach a constant maximum, without ever observing the reversion phenomenon. Furthermore, the vulcanisation kinetics is faster allowing for shorter vulcanisation cycles during industrial production.

Finally, the Applicant has observed that the viscosity and scorch values remained within acceptable values, thus allowing to maintain a good workability of the elastomeric composition.

Therefore, a first aspect of the present invention is a tyre comprising at least one structural element that includes a vulcanised elastomeric material obtained by vulcanisation of a vulcanisable elastomeric compound made by mixing an elastomeric composition comprising per 100 phr of diene elastomeric polymer:
(a) 30 to 95 phr of at least one styrene-butadiene polymer (SBR);
(b) 5 to 70 phr of at least one diene elastomeric polymer selected from the group consisting of at least one isoprene polymer (IR), at least one butadiene polymer (BR), or mixtures thereof;
(c) 10 phr to about 120 phr, preferably 20 phr to 100 phr, of at least one white reinforcing filler;
(d) from about 1% to about 20% by weight, relative to the amount of said white reinforcing filler, of at least one silane coupling agent;
(e) 1% to 35% by weight, preferably 5% to 25% by weight, relative to the amount of said silane coupling agent, of a polyamine.

According to a preferred embodiment, the tyre of the present invention comprises:
a carcass structure, having opposite side edges associated with respective left and right bead structures;
a tread band applied in a radially external position relative to said carcass structure;
a pair of sidewalls laterally applied on opposite sides to said carcass structure.

In a second aspect thereof, the present invention relates to an elastomeric composition comprising per 100 phr of diene elastomeric polymer:
(a) 30 to 95 phr of at least one styrene-butadiene polymer (SBR);
(b) 5 to 70 phr of at least one diene elastomeric polymer selected from the group consisting of at least one isoprene polymer (IR), at least one butadiene polymer (BR), or mixtures thereof;
(c) 10 phr to about 120 phr, preferably 20 phr to 100 phr, of at least one white reinforcing filler;
(d) from about 1% to about 20% by weight, relative to the amount of said white reinforcing filler, of at least one silane coupling agent;
(e) 1% to 35% by weight, preferably 5% to 25% by weight, relative to the amount of said silane coupling agent, of a polyamine.

### Definitions

The term “elastomeric composition” means a composition comprising at least one elastomeric polymer and one or more additives, which by mixing and possible heating provides an elastomeric compound suitable for use in tyres and components thereof. The elastomeric composition is made “vulcanisable” by the presence of vulcanising agents in the composition itself.

The components of the elastomeric composition are not generally introduced simultaneously into the mixer but typically added in sequence. In particular, the vulcanisation additives, such as the vulcanising agent and possibly the accelerant and retardant agents, are usually added in a downstream step with respect to the incorporation and processing of all the other components.

In the final vulcanisable elastomeric compound, the individual components of the elastomeric composition may be altered or no longer individually traceable as modified, completely or in part, due to the interaction with the other components, of heat and/or mechanical processing. The term “elastomeric composition” herein is meant to include the set of all the components that are used in the preparation of the elastomeric compound, regardless of whether they are actually present simultaneously, are introduced sequentially or are then traceable in the elastomeric compound or in the final tyre.

The term “elastomeric polymer” indicates a natural or synthetic polymer which, after vulcanisation, may be stretched repeatedly at room temperature to at least twice its original length and after removal of the tensile load substantially immediately returns with force to approximately its original length (according to the definitions of the ASTM D1566-11 Standard terminology relating to Rubber).

The term “diene polymer” indicates a polymer or copolymer derived from the polymerisation of one or more different monomers, among which at least one of them is a conjugated diene (conjugated diolefin). These polymers may be partially or fully hydrogenated.

The term “elastomeric compound” indicates the compound obtainable by mixing and possibly heating of an elastomeric composition comprising at least one elastomeric polymer with at least one of the additives commonly used in the preparation of tyre compounds.

The term “vulcanisable elastomeric compound” indicates the elastomeric compound ready for vulcanisation, obtainable by incorporation into an elastomeric compound of all the additives, including those of vulcanisation.

The term “vulcanised elastomeric compound” means the material obtainable by vulcanisation of a vulcanisable elastomeric compound.

The term “green” indicates a material, a compound, a composition, a component or a tyre not yet vulcanised.

The term “vulcanisation” refers to the cross-linking reaction in a natural or synthetic rubber induced by a typically sulphur-based cross-linking agent.

The term “vulcanisation agent” indicates a product capable of transforming natural or synthetic rubber into elastic and resistant material by virtue of the formation of a three-dimensional network of inter-and intra-molecular bonds. Typical vulcanising agents are sulphur-based compounds such as elemental sulphur, polymeric sulphur, sulphur-donor agents such as bis[(trialkoxysilyl)propyl]polysulphides, thiurams, dithiodimorpholines and caprolactam-disulphide.

The term “vulcanisation accelerant” means a compound capable of decreasing the duration of the vulcanisation process and/or the operating temperature, such as sulphenamides, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system.

The term “vulcanisation retardant” indicates a product capable of delaying the onset of the vulcanisation reaction and/or suppressing undesired secondary reactions, for example N-(cyclohexylthio) phthalimide (CTP).

The term “vulcanisation package” is meant to indicate the vulcanising agent and one or more vulcanisation additives selected from among vulcanisation activating agents, accelerants and retardants.

The term “reinforcing filler” is meant to refer to a reinforcing material typically used in the sector to improve the mechanical properties of tyre rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “white filler” is meant to refer to a conventional reinforcing material used in the sector selected from among conventional silica and silicates, such as sepiolite, paligorskite also known as attapulgite, montmorillonite, alloisite and the like, possibly modified by acid treatment and/or derivatised. Typically, white fillers have surface hydroxyl groups.

The term “mixing step (1)” indicates the step of the preparation process of the elastomeric compound in which one or more additives may be incorporated by mixing and possibly heating, except for the vulcanisation agent which is fed in step (2). The mixing step (1) is also referred to as “non-productive step”. In the preparation of a compound there may be several “non-productive” mixing steps which may be indicated with 1a, 1b, etc.

The term “mixing step (2)” indicates the next step of the preparation process of the elastomeric compound in which the vulcanising agent and, possibly, the other additives of the vulcanisation package are introduced into the elastomeric compound obtained from step (1), and mixed in the material, at controlled temperature, generally at a compound temperature lower than 120° C., so as to provide the vulcanisable elastomeric compound. The mixing step (2) is also referred to as “productive step”.

For the purposes of the present description and the following claims, the term “phr” (acronym for parts per hundreds of rubber) indicates the parts by weight of a given elastomeric compound component per 100 parts by weight of the elastomeric polymer, considered net of any extension oils.

Unless otherwise indicated, all the percentages are expressed as percentages by weight.

### DETAILED DESCRIPTION OF THE INVENTION

The present invention, in at least one of the aforementioned aspects, may exhibit one or more of the preferred features described below.

The elastomeric composition used to make at least one structural element of the tyre of the present invention comprises, per 100 phr of diene elastomeric polymer, 30 to 95 phr of at least one styrene-butadiene polymer (SBR), and 5 to 70 phr of at least one elastomeric polymer selected from the group consisting of at least one isoprene polymer (IR), at least one butadiene polymer (BR), or mixtures thereof.

According to one embodiment, the elastomeric composition used to make at least one structural element of the tyre of the present invention is a compound comprising, per 100 phr of diene elastomeric polymer:
(a) 40 to 70 phr, preferably 45 to 65 phr, of at least one styrene-butadiene polymer (SBR);
(b) 10 to 40 phr, preferably 15 to 35 phr, of at least one isoprene polymer (IR); and
(c) 20 to 50 phr, preferably 25 to 45 phr, of at least one butadiene polymer (BR).

According to another embodiment, the elastomeric composition used to make at least one structural element of the tyre of the present invention is a compound comprising, per 100 phr of diene elastomeric polymer:
(a) 50 to 80 phr, preferably 55 to 75 phr, of at least one styrene-butadiene polymer (SBR); and
(b) 20 to 50 phr, preferably 25 to 45 phr, of at least one butadiene polymer (BR).

According to a further embodiment, the elastomeric composition used to make at least one structural element of the tyre of the present invention is a compound comprising, per 100 phr of diene elastomeric polymer:
(a) 50 to 80 phr, preferably 55 to 75 phr, of at least one styrene-butadiene polymer (SBR); and
(b) 20 to 50 phr, preferably 25 to 45 phr, of at least one isoprene polymer (IR).

In the present context, styrene-butadiene (SBR) polymer is intended as a copolymer comprising monomer units of styrene and butadiene, with a percentage by weight of styrene preferably in the range from 10% to 55%, more preferably from 20% to 45%, and a weight percentage of vinyl (with respect to butadiene) preferably in the range from 10% to 70%, more preferably from 15% to 65%.

The styrene-butadiene polymer may contain, in addition to the styrene units and the butadiene units, a small amount, for example, equal to or less than 5% by weight, of additional monomer units such as isoprene, dimethylbutadiene, pentadiene, methylstyrene, ethylstyrene, divinylbenzene and diisopropenylbenzene.

Advantageously, the elastomeric composition according to the present invention comprises from 40 to 80 phr of at least one styrene-butadiene (SBR) polymer.

Preferably, the styrene-butadiene polymer is a random polymer.

Preferably, the styrene-butadiene polymer may have a weight average molecular weight of between 100,000 and 2,000,000 g/mol, preferably between 150,000 and 1,000,000, more preferably between 200,000 and 600,000 g/mol.

The styrene-butadiene polymer may be prepared according to known techniques, for example as described in US2019062535, in US2019062529 or in U.S. Pat. No. 4,547,560.

In one embodiment, the styrene-butadiene polymer is prepared by solution polymerisation (S-SBR).

Typically, solution synthesis provides polymers with a narrow molecular weight distribution, fewer chain branches, higher molecular weight and higher cis-1,4-polybutadiene content than polymers obtainable in emulsion.

In another embodiment, the styrene-butadiene polymer is prepared by emulsion polymerisation (E-SBR).

The styrene-butadiene polymer may be a functionalised polymer, such as for example the functionalised SBRs described in US2019062535 (par. 9-13), in US2019062529 (par. 19-22) in WO2017/211876A1 (component a) or in WO2015/086039A1.

The functional group may be introduced into the styrene-butadiene polymer by processes known in the art such as, for example, during the production of the styrene-butadiene polymer by copolymerisation with at least one corresponding functionalised monomer containing at least one ethylene unsaturation; or by subsequent modification of the styrene-butadiene polymer by grafting at least one functionalised monomer in the presence of a free radical initiator (for example, an organic peroxide).

Alternatively, the functionalisation may be introduced by reaction with suitable terminating agents or coupling agents. In particular, the styrene-butadiene polymers obtained by anionic polymerisation in the presence of an organometallic initiator (in particular, an organolithium initiator) may be functionalised by reacting the residual organometallic groups derived from the initiator with suitable terminating agents or coupling agents such as, for example, amines, amides, imines, carbodiimides, alkyltin halides, substituted benzophenones, alkoxysilanes, aryloxy silanes, alkylthiols, alkyldithiolsilanes, carboxyalkylthiols, carboxyalkylthiolsilanes, and thioglycols.

Useful examples of terminating agents or coupling agents are known in the art and described, for example in patents EP2408626, EP2271682, EP3049447A1, EP2283046A1, EP2895515A1, WO2015/086039A1 and WO2017/211876A1.

Commercial examples of SBR polymers useful in the present invention are Tufdene E581 and E680 polymers from Asahi-Kasei (Japan), SPRINTAN SLR4602, SLR3402, SLR4630 and 941S from Trinseo (Germany), BUNA SL-4518 and BUNA SE 1502 from Arlanxeo (Germany), Europrene 5543T, Europrene 1739 and Intol 1789 from Eni (Italy), HPR620 and HP 755 from Japan Synthetic Rubber Co. (Japan), and NIPOL NS 522 from Zeon Co. (Japan).

In the present context, isoprene polymer or isoprene rubber (IR) means a synthetic or natural elastomer obtained by 1,4-cis addition of isoprene. Preferably, the isoprene polymer is a natural rubber (NR). Isoprene polymers and natural rubbers are well known to those skilled in the field of tyres. The isoprene polymer may optionally be functionalised with the same terminating or coupling agents described above.

Advantageously, the elastomeric composition according to the present invention comprises from 10 to 50 phr of at least one isoprene polymer (IR).

A commercial example of suitable isoprene polymer is SIR20 from Aneka Bumi Pratama or STR 20 from Thaiteck Rubber.

The polybutadiene polymer (BR) is a synthetic rubber obtained by polymerisation of 1,3-butadiene, preferably by nickel or neodymium catalysis.

The polybutadiene polymer preferably comprises a polybutadiene rubber with a cis group content greater than 90%, more preferably greater than 95%. The cis content of the polybutadiene rubber is usually provided by the supplier and may be determined by the FTIR method. The method is based on the calculation of the ratio between the intensity of the bands attributable to the 1,4-trans and 1,2-vinyl isomers and a reference band (internal standard) which falls at 1312 cm⁻¹ (L. J. Bellamy, The Infrared Spectra of Complex Molecules, Vol. 1 Third Edition, Chapman and Hall). The 1,4-cis content is determined by the difference to 100. The preparation of the sample is carried out on a polybutadiene film, obtained starting from a solution, evaporated on a KBr window.

Advantageously, the elastomeric composition according to the present invention comprises from 20 to 50 phr of at least one butadiene polymer (BR).

Commercial examples of polybutadiene rubber include ND-PBR (SKDN) from PJSC Nizhnekamskneftekhim (Russia), Europrene NEOCIS BR 60 from ENI (Italy), Buna® CB 22 from Arlanxeo (Germany), Nd BR 40 from KUMHO (South Korea).

According to one embodiment, the diene elastomeric polymers used in the elastomeric composition of the present invention, in particular the styrene-butadiene polymer (SBR), the isoprene polymer (IR), and the butadiene polymer (BR), may be partially or fully hydrogenated. According to the first variant, a fraction of the diene units of the diene elastomeric polymer is hydrogenated. According to the second variant, all the diene units of the diene elastomeric polymer are hydrogenated. The partial or total hydrogenation process partially or totally reduces the double bonds of the diene elastomeric polymer to single bonds. The reduction of the double bonds may also occur with processes other than hydrogenation, such as for example with aluminium hydride reduction processes or with diimide.

The white reinforcing filler is preferably selected from conventional silica and silicates, in the form of fibres, flakes or granules, such as bentonite, nontronite, beidellite, volkonskoite, hectorite, saponite, sauconite, vermiculite, sericite, sepiolite, paligorskite also known as attapulgite, montmorillonite, alloisite and the like, possibly modified by acid treatment and/or derivatised, and mixtures thereof, more preferably it is silica. Examples of silica are a pyrogenic silica, a precipitated amorphous silica, a wet silica (hydrated silicic acid), or mixtures thereof.

Preferably, the white reinforcing filler has a specific surface area (BET) of at least 30 m²/g, more preferably of at least 50 m²/g, and even more preferably of at least 80 m²/g.

Preferably, the non-functionalised white reinforcing filler has a specific surface area (BET) of less than 400 m²/g, more preferably less than or equal to 250 m²/g, and even more preferably less than or equal to 220 m²/g.

Advantageously, the white reinforcing filler has a specific surface area (BET) from about 50 m²/g to about 350 m²/g, more preferably from about 70 m²/g to about 240 m²/g, even more preferably from about 90 m²/g to about 190 m²/g.

Examples of suitable commercial silicas are products sold under the brand name Hi-Sil® of PPG Industries (Pittsburgh, Pa.), Ultrasil® of Evonik, or Zeosil® of Solvay, such as the precipitated silica Rhodia Zeosil MP1165 (BET area specific surface area 160 m²/g), Ultrasil VN3 GR (BET specific surface area 180 m²/g) and Zeosil 1115 MP (BET specific surface area 95-120 m²/g).

For some applications, the elastomeric composition may comprise, in addition to said white reinforcing filler, at least 1 phr, more preferably at least 2 phr, more preferably at least 3 or 4 phr of carbon black.

Carbon black may be selected from those of standard grade for tyres, or having a surface area not smaller than 20 m²/g, more preferably greater than 50 m²/g (measured in accordance with the ASTM D6556-16 standard).

Commercial examples of carbon black are N375 or N234 marketed by Birla Group (India) or Cabot Corporation.

Optionally, the elastomeric composition may comprise one or more reinforcing fillers as defined above in a mixture.

Advantageously, the elastomeric composition comprises at least one silane coupling agent capable of interacting with the white reinforcing filler and binding it to the elastomeric polymer during vulcanisation.

The silane coupling agents preferably used are those which may be represented by the following structural formula (I):

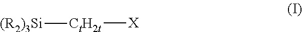

wherein the R₂ groups, which may be equal or different from each other, are selected from: alkyl, alkoxy or aryloxy groups or halogen atoms, with the proviso that at least one of the R₂ groups is an alkoxy or an aryloxy group; t is an integer of between 1 and 6 inclusive; X is a group selected from nitrose, mercapto, amino, epoxide, vinyl, imide, chlorine, —(S)ᵤCₜH₂ₜ—Si—(R₂)₃ or —S—COR₂, wherein u and t are integers of between 1 and 6, ends included and the R₂ groups are as defined above.

Particularly preferred silane coupling agents are amino-silanes and sulpho-silanes.

According to one embodiment, the silane coupling agent is an amino-silane represented by the following formula (II):

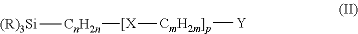

wherein
the R groups, equal or different from each other, are selected from alkyl or alkoxy groups having from 1 to 4 carbon atoms, provided that at least one of the R groups is an alkoxy group;
n and m, equal to or different from each other, are an integer from 1 to 6 inclusive;
p is an integer from 0 to 5 inclusive;
X is an —NH— group, and
Y is an —NH₂ or NHR′ group, where R′ is an alkyl or cycloalkyl group of 1 to 6 carbon atoms.

Amino silanes usable in the present invention represented by the formula (II) are 2-aminoethyltrimethoxysilane, 2-aminoethyltriethoxysilane, 2-aminoethyltripropoxysilane, 2-aminoethyltributoxysilane, 3-aminopropyltrimethoxysilane, 3-aminopropyltriethoxysilane (APTES), 3-aminopropyl-methyldiethoxysilane, 3-aminopropyl-methyldimethoxysilane, 3-aminopropyl-diisopropylethoxysilane, 3-aminopropyltris-(methoxyethoxyethoxy)silane, 3-aminopropyl-diisopropylethoxysilane, 3-(2-aminomethylamino)propyl-triethoxysilane, 3-(2-(2-aminoethylamino)ethylamino)propyltrimethoxysilane, 4-aminobutyltriethoxysilane, 4-aminobutyldimethylmethoxysilane, 4-aminobutyltriethoxysilane, N-(2-aminoethyl)aminomethyltriethoxysilane, N-(2-aminoethyl)-3-aminopropyl-trimethoxysilane (also known as N-[3-(trimethoxysilyl)propyl]ethylenediamine (EDTMS)), N-(2-aminoethyl)-3-aminopropyl-triethoxysilane, N-(2-aminoethyl)-3-aminopropyl-tris(2-ethylethoxy)silane, N-(2-aminoethyl)-3-aminopropyl-methyldimethoxysilane, N-(2-aminoethyl)-3-aminopropyl-methyldiethoxysilane, N-(2-aminoethyl)-3-aminooisobutyl-methyldimethoxysilane, N-(6-aminohexyl)-3-aminopropyl-trimethoxysilane, N-(6-aminohexyl)-3-aminopropyl-triethoxysilane, N-2-(vinylbenzylamino)-ethyl-3-aminopropyl-trimethoxysilane, N-cyclohexyl(aminomethyl)methyldiethoxysilane, N-cyclohexyl(aminomethyl)triethoxysilane, N-cyclohexyl(aminomethyl)trimethoxysilane, N-cyclohexyl-3-aminopropyl-trimethoxysilane, N-(n-butyl)-3-aminopropyl-trimethoxysilane, N-(n-butyl)-3-aminopropyltriethoxysilane, N-(n-butyl)-aminomethyltriethoxysilane, N,N-diethylaminopropyltrimethoxysilane, N,N-dimethylaminopropyltrimethoxysilane, N,N-diethylaminomethyltriethoxysilane.

According to one embodiment, the silane coupling agent is a sulpho-silane represented by the following formula (III):

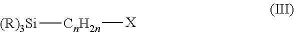

wherein
X is a mercapto group (—SH), or —(S)ₘCₙH₂ₙ—Si—(R)₃
the R groups, equal or different from each other, are selected from alkyl or alkoxy groups having from 1 to 4 carbon atoms, provided that at least one of the R groups is an alkoxy group; and
n and m, equal to or different from each other, are an integer from 1 to 6 inclusive.

Sulpho-silanes usable in the present invention represented by formula (III) are bis[3-(trimethoxysilyl)propyl]-tetrasulphane (TESPT), bis[3-(triethoxysilyl)propyl]-disulphane (TESPD), bis[2-(trimethoxysilyl)ethyl]-tetrasulphane, bis[2-(triethoxysilyl)ethyl]-trisulphane, bis[3-(trimethoxysilyl)propyl]-disulphane, (1-mercaptomethyl)triethoxysilane, (2-mercaptoethyl)triethoxysilane, (3-mercaptopropyl)triethoxysilane, (3-mercaptopropyl)methyldietoxysilane, (3-mercaptopropyl)methyldimethoxysilane, (3-mercaptopropyl)trimethoxysilane, 3-octanoylthio-1-propyltriethoxysilane and (2-mercaptoethyl)tripropoxysilane.

Preferred compounds represented by the formula (II) and (III) are (i) amino silanes selected from the group consisting of (3-aminopropyl)triethoxysilane (APTES), (3-aminopropyl)trimethoxysilane, N-(2-aminoethyl)-3-aminopropyl trimethoxysilane [also known as N-[3-(trimethoxysilyl)propyl]ethylenediamine (EDTMS)], and N-(2-aminoethyl)-3-aminopropyltriethoxysilane, and (ii) sulpho-silanes selected from the group consisting of bis[3-(trimethoxysilyl)propyl]-tetrasulphane (TESPT), bis[3-(triethoxysilyl)propyl]-disulphane (TESPD), and (3-mercaptopropyl)trimethoxysilane.

Preferably, the silane coupling agent is added to the elastomeric composition in an amount ranging from 5 to 15% by weight, and more preferably from 6 to 10% by weight, based on the weight of white reinforcing filler.

Advantageously, the elastomeric composition comprises a polyamine capable of interacting with the white reinforcing filler and with the silane coupling agent and promoting their distribution within the elastomeric composition and the silanisation process.

The polyamine is present in the elastomeric composition in an amount ranging from 1% to 35% by weight, preferably from 5% to 25% by weight, with respect to the amount of said silane coupling agent.

The polyamine useful for the purposes of the present invention consists of an aliphatic organic compound, linear or branched, comprising at least three amino groups, wherein said amino groups may be primary (—NH₂), secondary (—NH—) or tertiary (═N—).

According to one embodiment, the polyamine useful for the purposes of the present invention is represented by the following formula (IV):

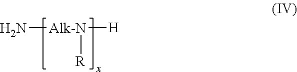

where x is an integer from 2 to 6, R is a hydrogen atom or alkyl group having 1 to 3 carbon atoms, and Alk is a divalent linear-chain alkylene group having 1 to 8 carbon atoms.

In one embodiment, polyamines useful for purposes of the present invention are, for example, diethylene triamine, triethylene tetraamine, tetraethylene pentamine, pentaethylene hexamine, heptaethylene octamine, dipropylene triamine, tripropylene tetraamine, tetrapropylene pentamine, dibutylene triamine, tributylene tetraamine, tetrabutylene pentamine, dimethylene triamine, trimethylene tetraamine, tetramethylene pentamine, pentamethylene hexamine, di(heptamethylene) triamine, di(trimethylene) triamine, decaethylene endecamine, decamethylene endecamine, N,N-dimethyl diethylene triamine, N,N-dimethyl tetraethylene pentamine, N,N-diethyl tetraethylene pentamine, N,N′,N″-trimethyldiethylene triamine, dipentylene triamine, triesylene tetraamine, tetraheptylene pentamine, trioctylene tetraamine, and tetrapentylene pentamine.

Particularly preferred polyamines are tetramines, such as, for example, trimethylene tetramine, triethylene tetramine, and tripropylene tetramine. Triethylene tetramine is advantageously preferred.

The elastomeric composition described above may be vulcanised according to known techniques, in particular with sulphur-based vulcanising systems commonly used to make vulcanisable elastomeric compounds. To this end, after one or more thermo-mechanical processing steps, a sulphur-based vulcanisation agent is incorporated in the elastomeric composition, together with vulcanisation accelerants. In the final processing step, the temperature is generally kept below 120° C. and preferably below 100° C., so as to avoid any undesired pre-cross-linking phenomenon.

The vulcanisation agent is preferably selected from sulphur, or alternatively, sulphur-containing molecules (sulphur donors), such as for example caprolactam disulphide (CLD), bis(trialcoxysilyl)propyl]polysulphides, dithiophosphates, phosphorylpolysulphide (SDT) and mixtures thereof.

Preferably, the vulcanising agent is sulphur preferably selected from soluble sulphur (crystalline sulphur), insoluble sulphur (polymeric sulphur), (iii) oil-dispersed sulphur and mixtures thereof.

Commercial examples of suitable vulcanising agents are the 65% sulphur known under the trade name of Rhenogran of Lanxess, the 67% sulphur known under the trade name of Crystex OT33 of Eastman, the 95% sulphur known under the trade name of Solvay SchwefelKC, the rhombic crystalline sulphur known under the trade name of Sulphur (1% oil and 0.3% silica) of Zolfindustria.

The vulcanisation agent may be present in the elastomeric composition in an overall amount generally of from 0.1 to 15 phr, preferably from 0.5 to 10 phr, even more preferably from 1 to 7 phr.

The elastomeric composition may comprise one or more vulcanisation agents as defined above in mixture.

The vulcanisation agent is preferably used together with adjuvants such as vulcanisation activating agents, accelerants and/or retardants known to those skilled in the art.

The activating agents which are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, as well as BiO, PbO, Pb₃O₄, PbO₂ or mixtures thereof.

The vulcanisation accelerant agent is preferably selected from dithiocarbamates, guanidines, thioureas, thiazoles, sulphenamides, sulphenimides, thiurams, amines, xanthates and mixtures thereof.

Preferably, the accelerant agent is selected from N-cyclohexyl-2-benzothiazol-sulphenamide (CBS), N-tert-butyl-2-benzothiazol-sulphenamide (TBBS) and mixtures thereof.

A commercial example of a suitable accelerant agent is N-cyclohexyl-2-benzothiazol-sulphenamide Vulkacit® (CBS or CZ) marketed by Lanxess.

The accelerant agent may be present in the elastomeric composition in an overall amount generally ranging between 0.05 phr and 10 phr, preferably between 0.1 phr and 5 phr.

The elastomeric composition may comprise one or more accelerant agents as defined above in mixture.

The vulcanisation retardant agent may be selected for example from urea, phthalic anhydride, N-nitrosodiphenylamine N-cyclohexylthiophthalimide (CTP or PVI), and mixtures thereof.

A commercial example of a suitable retardant agent is N-cyclohexylthiophthalimide VULKALENT G of Lanxess.

The retardant agent may be present in the elastomeric composition in an amount generally ranging between 0.05 phr and 2 phr.

The elastomeric composition may comprise one or more retardant agents as defined above in mixture.

The elastomeric composition may comprise other commonly used additives selected based on the specific application for which the elastomeric composition is intended. For example, the following may be added to said elastomeric composition: antioxidants, anti-ageing agents, plasticisers, adhesives, antiozonants (especially of the p-phenylenediamine type), waxes, modified resins, fibres (e.g. Kevlar® paste), or mixtures thereof.

The antioxidant may be selected from the group comprising phenylenediamine, diphenylamine, dihydroquinoline, phenol, benzimidazole, hydroquinone and derivatives thereof, optionally in mixture.

The antioxidant agent is preferably selected from N-isopropyl-N′-phenyl-p-phenylenediamine (IPPD), N-(1,3-dimethyl-butyl)-n′-phenyl-p-phenylenediamine (6PPD), N,N′-bis-(1,4-dimethyl-pentyl)-p-phenylenediamine (77PD), N,N′-bis-(1-ethyl-3-methyl-pentyl)-p-phenylenediamine (DOPD), N,N′-bis-(1,4-dimethyl-pentyl)-p-phenylenediamine, N,N′-diphenyl-p-phenylenediamine (DPPD), N,N′-ditolyl-p-phenylenediamine (DTPD), N,N′-di-beta-naphthyl-p-phenylenediamine (DNPD), N,N′-bis(1-methylheptyl)-p-phenylenediamine, N,N′-Di-sec-butyl-p-phenylenediamine (44PD), N-phenyl-N-cyclohexyl-p-phenylenediamine, N-phenyl-N′-1-methylheptyl-p-phenylenediamine and the like and mixtures thereof, preferably it is N-(1,3-dimethyl-butyl)-N′-phenyl-p-phenylenediamine (6-PPD).

A commercial example of a suitable antioxidant agent is 6PPD of Solutia/Eastman.

The antioxidant agent may be present in the elastomeric composition in an overall amount generally ranging between 0 phr and 20 phr, preferably between 0.5 phr and 10 phr.

The wax may be for example a petroleum wax or a mixture of paraffins.

Commercial examples of suitable waxes are the Repsol N-paraffin mixture and the Antilux® 654 microcrystalline wax from Rhein Chemie.

The wax may be present in the elastomeric composition in an overall amount generally ranging between 0 phr and 20 phr, preferably between 0.5 phr and 5 phr.

In order to further improve the processability, the elastomeric composition may be admixed with at least one plasticiser agent generally selected from mineral oils, vegetable oils, synthetic oils, polymers with a low molecular weight and mixtures thereof, such as, for example, aromatic oil, naphthenic oil, phthalates, soybean oil and mixtures thereof. The amount of plasticiser generally ranges from 0 phr and 70 phr, preferably from 5 phr to 30 phr.

The vulcanisable elastomeric compound resulting from the elastomeric composition according to the present invention and the addition of the above additives may be prepared by mixing together the basic elastomeric components together with the other optionally present additives, according to the techniques known in the art. The mixing steps may be performed, for example, using an open mixer of the cylinder type or an internal mixer of the type with tangential rotors (Banbury®) or with interpenetrating rotors (Intermix®), or in continuous mixers of the Ko-Kneader™ type (Buss®) or of the co-rotating or counter-rotating twin-screw type.

The tyre according to the present invention may be manufactured according to a process which comprises:
building components of a green tyre on at least one forming drum;
shaping, moulding and vulcanising the tyre;
   wherein building at least one of the components of a green tyre comprises:
manufacturing at least one green component comprising the elastomeric composition of the invention.

### DESCRIPTION OF THE DRAWINGS

The description is given hereinafter with reference to the accompanying drawings, provided only for illustrative and, therefore, non-limiting purposes, in which:

FIG. 1 shows a cross half-section showing a tyre for motor vehicle wheels according to a first embodiment of the present invention,

FIG. 2 shows a Cartesian graph relating to the vulcanisation curves of the elastomeric compounds REF1 and INV1-INV5 described in Example 1, and

FIG. 3 shows a Cartesian graph relating to the vulcanisation curves of the elastomeric compounds REF2 and OT1-OT2 described in Example 2.

FIG. 4 shows a Cartesian graph relating to the vulcanisation curves of the elastomeric compounds REF BR, INV BR and OT BR described in Example 3.

FIG. 5 shows a Cartesian graph relating to the vulcanisation curves of the elastomeric compounds REF NR, INV NR and OT NR described in Example 4.

The present description relates by way of example to a tyre for motor vehicle wheels. The Applicant believes that the present invention may also be applied to tyres for different vehicles such as motorcycles and bicycles.

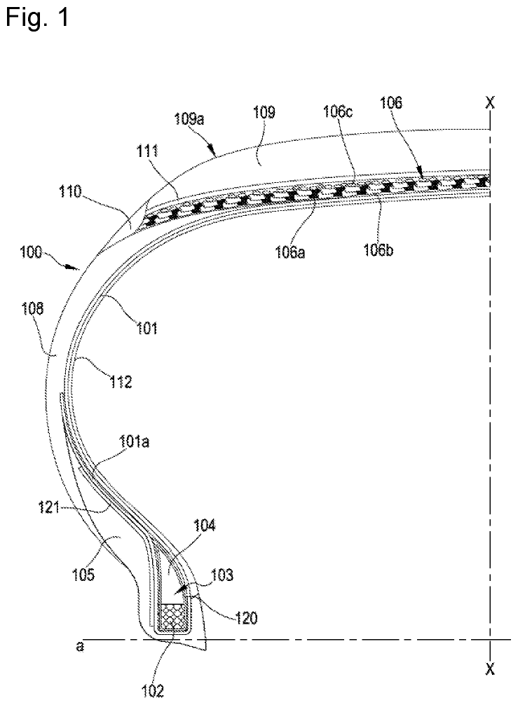

In FIG. 1, “a” indicates an axial direction and “x” indicates a radial direction. For simplicity, FIG. 1 shows only a portion of the tyre, the remaining portion not shown being identical and arranged symmetrically with respect to the radial direction “x”.

With reference to FIG. 1, the tyre 100 for motor vehicle wheels comprises at least one carcass structure, comprising at least one carcass layer 101 of elastomeric material having respectively opposite end flaps engaged with respective annular anchoring structures 102, referred to as bead cores, possibly associated to a bead filler 104 of elastomeric material. The tyre area comprising the bead core 102 and the filler 104 forms a reinforcement annular structure 103, the so-called bead, intended for anchoring the tyre onto a corresponding mounting rim, not shown.

The carcass structure is usually of radial type, i.e. the reinforcing elements of the at least one carcass layer 101 lie on planes comprising the rotational axis of the tyre and substantially perpendicular to the equatorial plane of the tyre. Said reinforcing elements generally consist of textile cords, such as rayon, nylon, polyester (for example polyethylene naphthalate, PEN). Each reinforcement annular structure is associated to the carcass structure by folding back of the opposite lateral edges of the at least one carcass layer 101 around the annular anchoring structure 102 so as to form the so-called carcass flaps 101a as shown in FIG. 1.

In one embodiment, the coupling between the carcass structure and the reinforcement annular structure may be provided by a second carcass layer (not shown in FIG. 1) applied in an axially external position with respect to the first carcass layer.

An anti-abrasive strip 105 of elastomeric material is arranged in an external position of each reinforcement annular structure 103. Preferably each anti-abrasive strip 105 is arranged at least in an axially external position to the reinforcement annular structure 103 extending at least between the sidewall 108 and the portion radially below the reinforcement annular structure 103.

Preferably, the anti-abrasive strip 105 is arranged so as to enclose the reinforcement annular structure 103 along the axially internal and external and radially lower areas of the reinforcement annular structure 103 so as to interpose between the latter and the wheel rim when the tyre 100 is mounted to the rim.

The carcass structure is associated to a belt structure 106 of elastomeric material comprising one or more belt layers 106a, 106b placed in radial superposition with respect to one another and with respect to the carcass layer, having typically metallic reinforcing cords. Such reinforcing cords may have crossed orientation with respect to a direction of circumferential development of the tyre (100). By “circumferential” direction it is meant a direction generally facing in the direction of rotation of the tyre.

At least one zero-degree reinforcement layer 106c, commonly known as a “0° belt”, may be applied in a radially outermost position to the belt layers 106a, 106b, which generally incorporates a plurality of reinforcement cords, typically textile cords, oriented in a substantially circumferential direction, thus forming an angle of a few degrees (such as an angle of between about 0° and 6°) with respect to the equatorial plane of the tyre, and coated with an elastomeric material.

A tread band 109 of elastomeric material is applied in a position radially external to the belt structure 106.

Moreover, respective sidewalls 108 of elastomeric material are further applied in an axially external position on the lateral surfaces of the carcass structure, each extending from one of the lateral edges of the tread 109 at the respective reinforcement annular structure 103. In a radially external position, the tread band 109 has a rolling surface 109a intended to come in contact with the ground. Circumferential grooves, which are connected by transverse notches (not shown in FIG. 1) so as to define a plurality of blocks of various shapes and sizes distributed over the rolling surface 109a, are generally made on this surface 109a, which for simplicity is represented smooth in FIG. 1.

An under-layer 111 of elastomeric material is arranged between the belt structure 106 and the tread band 109.

A strip consisting of elastomeric material 110, commonly known as “mini-sidewall”, may optionally be provided in the connecting zone between the sidewalls 108 and the tread band 109, this mini-sidewall being generally obtained by co-extrusion with the tread band 109 and allowing an improvement of the mechanical interaction between the tread band 109 and the sidewalls 108. Preferably, the end portion of sidewall 108 directly covers the lateral edge of the tread band 109.

In the case of tubeless tyres, a layer of elastomeric material 112, generally known as “liner”, which provides the necessary impermeability to the inflation air of the tyre, may also be provided in a radially internal position with respect to the carcass layer 101.

The rigidity of the tyre sidewall 108 may be improved by providing the bead structure 103 with a reinforcing layer 120 generally known as “flipper” or additional strip-like insert. The flipper 120 typically comprises a plurality of textile cords incorporated within a layer of elastomeric material.

The flipper 120 is a reinforcing layer which is wound around the respective bead core 102 and the bead filler 104 so as to at least partially surround them, said reinforcing layer being arranged between the at least one carcass layer 101 and the bead structure 103. Usually, the flipper is in contact with said at least one carcass layer 101 and said bead structure 103.

The bead structure 103 of the tyre may comprise a further protective layer which is generally known by the term of “chafer” 121 or protective strip and which has the function of increasing the rigidity and integrity of the bead structure 103.

The chafer 121 usually comprises a plurality of cords incorporated within a layer of elastomeric material. Such cords are generally made of textile materials (such as aramide or rayon) or metal materials (such as steel cords).

The elastomeric composition according to the present invention may be advantageously used to make the elastomeric material incorporated in one or more of the components of the tyre selected from the tread band, the tread underlayer, the sidewall and in general any structural element in which silica is used as a reinforcing element, preferably in the tread, even when made in two radially overlapping layers (known as “cap and base” tread) with a radially external portion (“cap”) and a radially internal portion (“base”) comprising different amounts of silica.

The use of the elastomeric composition to make the elastomeric material of the aforesaid components allows a tyre with a lower rolling resistance to be obtained, and consequently a lower development of heat and fuel consumption, at the same time obtaining a good tearing resistance of the tyre surface, and good handling during use of the same.

The building of the tyres 100 as described above may be carried out by assembling respective semi-finished products onto a forming drum, not shown, by at least one assembly device.

At least a part of the components intended to form the carcass structure of the tyre may be built and/or assembled on the forming drum. More particularly, the forming drum is intended to first receive the possible liner, then the carcass structure and the anti-abrasive strip. Thereafter, devices non shown coaxially engage one of the annular anchoring structures around each of the end flaps, position an external sleeve comprising the belt structure and the tread band in a coaxially centred position around the cylindrical carcass sleeve and shape the carcass sleeve according to a substantially toroidal configuration through a radial expansion of the carcass structure, so as to cause the application thereof against a radially internal surface of the external sleeve.

After the building of the green tyre, a moulding and vulcanisation treatment is generally carried out in order to determine the structural stabilisation of the tyre through cross-linking of the elastomeric compositions, as well as to impart a desired tread pattern on the tread band and to impart any distinguishing graphic signs at the sidewalls.

According to an embodiment not shown, the tyre may be a tyre for motorcycle wheels which is typically a tyre that has a straight section featuring a high tread camber.

According to an embodiment not shown, the tyre may be a tyre for bicycle wheels.

The description of some preparatory and comparative examples according to the invention is given below, provided for illustrative and non-limiting purposes only of the scope of protection of the present invention.

### EXPERIMENTAL PART

### Analysis Methods

The scorch time represents the time required to increase the Mooney viscosity by 5 points. The value in minutes was measured at 127° C. in accordance with the ISO 289/2 standard (1994).

Mooney ML (1+4) viscosity at 100° C. was measured according to the ISO 289-1:1994 standard, on non-vulcanised elastomeric compositions.

The IRHD hardness was measured at 23° C. on vulcanised elastomeric compositions according to the ISO 48:2007 standard.

MDR rheometric analysis (according to ISO 6502): a rheometer Alpha Technologies type MDR2000 was used. The tests were carried out at 170° C. for 30 minutes, at an oscillation frequency of 1.66 Hz (100 oscillations per minute) and an oscillation amplitude of ±0.5°, measuring the minimum torque value (ML), maximum torque (MH), the time required to increase the torque by two units (TS2), and the time necessary to reach different percentages (30, 60 and 90%) of the maximum torque value (MH).

The percentage of silanisation is the percentage ratio between the silane reacted with the silica and the total amount of silane available. The evaluation of the unreacted silane was carried out after the first mixing step. Unreacted silane is removed from the material by dissolution in solvent. The resulting solution is chemically analysed to identify the Si—C bond concentration. The amount of Si—C bond found in the solution is in proportion to the amount of unreacted silane. The percentage of silanisation is calculated from the ratio of the concentration of the unreacted silane to the concentration of the initial silane present in the recipe.

### Properties of Vulcanised Materials

The elastomeric materials prepared in the previous examples were vulcanised to give specimens on which analytical characterisations and the assessment of dynamic mechanical properties were conducted. Unless otherwise indicated, vulcanisation was carried out in a mould, in hydraulic press at 170° C. and at a pressure of 200 bar for about 10 minutes.

Static modules: static mechanical properties were measured at 23° C. according to the ISO 37:2005 standard. In particular, the tensile stresses at various levels of elongation (100% and 300%, named in the order CA1 and CA3), the load and the elongation at break (CR, AR, respectively) were measured on ring-shaped samples of vulcanised elastomeric compositions.

Dynamic modules: dynamic mechanical properties were measured using an Instron dynamic device in compression and tension operation with the following method. A sample of vulcanised elastomeric cylindrical compositions (height=25 mm; diameter=14 mm), preload in compression up to 25% of longitudinal deformation with respect to the initial length and maintained at the predetermined temperature (−10° C., 23° C. or 70° C.) during the test was subjected to a dynamic sinusoidal voltage with amplitude ±3.5% with respect to the length of the preload, at a frequency of 100 Hz.

The dynamic mechanical properties are expressed in terms of dynamic elastic modulus (E′) and Tan delta (loss factor). The Tan delta value was calculated as the ratio between the viscous dynamic module (E″) and the dynamic elastic modulus (E′).

DIN abrasion is the amount of compound removed by operating under the standard conditions given in DIN 53516 or ISO4649 standard.

The normalised abrasion is obtained by multiplying the DIN abrasion value by the ratio between the CA3 value of the reference and the sample in question.

### Example 1

In this example a reference compound was compared with compounds of the invention comprising an increasing amount of triethylenetetramine replacing a portion of the silane coupling agent.

The elastomeric materials listed in the following Table 1 were prepared as follows (the amounts of the various components are indicated in phr).

In the first step, the elastomeric components, the white reinforcing filler, the silane coupling agent, and triethylenetetramine were mixed in an internal mixer (model Pomini PL 1,6) for about 6 minutes up to about 135° C. In the second step, the zinc-based components and the other protectives were added, and the mixing continued for about 4 minutes up to about 135° C. Finally, sulphur and the other vulcanisation additives were added, mixing for a further 2 minutes up to about 95° C., then the vulcanisable elastomeric compound was discharged.

TABLE 1

| | COMPOSITION | | | | | |
|---|---|---|---|---|---|---|
| INGREDIENTS | REF1 | INV1 | INV2 | INV3 | INV4 | INV5 |
| NR | 25 | 25 | 25 | 25 | 25 | 25 |
| BR | 30 | 30 | 30 | 30 | 30 | 30 |
| SSBR | 62 | 62 | 62 | 62 | 62 | 62 |
| Carbon black | 5 | 5 | 5 | 5 | 5 | 5 |
| Silica | 95 | 95 | 95 | 95 | 95 | 95 |
| TESPT | 7.6 | 5.9 | 5.9 | 5.9 | 5.9 | 5.9 |
| TETA | — | 1.7 | 1.35 | 1.0 | 0.65 | 0.33 |
| Stearic acid | 3 | 3 | 3 | 3 | 3 | 3 |
| Wax | 2 | 2 | 2 | 2 | 2 | 2 |
| Resin 1 | 8 | 8 | 8 | 8 | 8 | 8 |
| Resin 2 | 19 | 19 | 19 | 19 | 19 | 19 |
| ZnO | 2.7 | 2.7 | 2.7 | 2.7 | 2.7 | 2.7 |
| 6PPD | 5 | 5 | 5 | 5 | 5 | 5 |
| CBS | 2 | 2 | 2 | 2 | 2 | 2 |
| PVI | 0.3 | 0.3 | 0.3 | 0.3 | 0.3 | 0.3 |
| Sulphur | 1 | 1 | 1 | 1 | 1 | 1 |

NR: Natural Rubber - SIR 20 - Standard Indonesia Rubber
BR: Standard Polybutadiene (High Cis 97%) - SKD NHEODIMIO - (Nizhnekamskneftekhim Export)
SSBR: Styrene butadiene copolymer, extended with 37.5 parts of TDAE oil for every 100 parts of dry polymer - microstructure with 24.9% styrene and 61.7% vinyl on the butadiene fraction - SPRINTAN ™ SLR 4630 - Trinseo
Carbon black: N330 from Cabot Corporation
Silica: Ultrasil ® 7000 - Evonik
TESPT: bis[3-(triethoxysilyl)propyl]tetrasulphide - SI69 ® - Evonik
TETA: Triethylenetetramine -
Wax: RIOWAX BM-01 - Ser SpA
Resin 1: Polybutadiene - Polyvest ® 130 - Evonik
Resin 2: Styrene-butadiene copolymer - Ricon ® 100
ZnO: Standard Zn oxide from A-Esse;
6PPD: N-(1,3-dimethylbutyl)-N′-phenyl-p-phenylene-diamine SANTOFLEX 6PPD from EASTMAN;
CBS: N-cyclohexylbenzothiazole-2-sulphenamide RUBENAMID C EG/C from GENERAL QUIMICA.
Sulphur: Sulphur 98.50% (1% oil) - Zolfindustria

The vulcanisable elastomeric compounds thus prepared above were evaluated for the behaviour in vulcanisation (170° C., 30 min) and subsequently, in terms of static and dynamic mechanical and wear resistance properties according to the methods described above. The following Table 2 shows the rheometric, mechanical, dynamic and static features of the compositions of Table 1.

TABLE 2

| | | | | | |
|---|---|---|---|---|---|
| REF1 | INV1 | INV2 | INV3 | INV4 | INV5 |

Rheometric features

| Mooney ML(1 + 4) 100° C. | | 66.4 | 72.6 | 76.3 | 79.0 | 73.7 | 72.3 |
|---|---|---|---|---|---|---|---|
| Scorch 127° C. [min] | | 22.4 | 8.5 | 12.1 | 16.5 | 21.4 | 23.8 |
| ML [dN m] | 30 min | 4.1 | 4.2 | 4.0 | 4.1 | 3.9 | 4.2 |
| MH [dN m] | 170° C. | 21.7 | 16.8 | 17.7 | 18.6 | 18.4 | 19.8 |
| TS2 [min] | | 1.0 | 0.5 | 0.6 | 0.8 | 0.9 | 1.0 |
| T30 [min] | | 1.5 | 0.6 | 0.8 | 1.1 | 1.3 | 1.5 |
| T60 [min] | | 2.3 | 0.8 | 1.0 | 1.4 | 1.7 | 2.0 |
| T90 [min] | | 7.7 | 1.4 | 1.7 | 2.1 | 2.9 | 4.5 |

| | | | | | | |
|---|---|---|---|---|---|---|
| Silanisation [% w/w] | 96.7 | 99.8 | — | 99.8 | — | — |

Static mechanical features

| | | | | | | |
|---|---|---|---|---|---|---|
| Density [g/cm³] | 1.200 | 1.202 | 1.201 | 1.201 | 1.200 | 1.200 |
| Ca1 [MPa] | 1.9 | 2.1 | 1.9 | 2.0 | 1.8 | 1.7 |
| Ca3 [MPa] | 7.1 | 8.6 | 8.1 | 8.1 | 7.0 | 6.6 |
| Ca3/Ca1 | 3.8 | 4.1 | 4.2 | 4.1 | 3.9 | 3.9 |
| CR [MPa] | 14.2 | 14.1 | 15.4 | 14.4 | 12.9 | 14.4 |
| AR [%] | 545.3 | 464.5 | 505.9 | 487.7 | 502.2 | 563.1 |
| IRHD hardness 23° C. | 76.1 | 71.4 | 71.4 | 71.8 | 72.5 | 72.9 |

Dynamic mechanical features

| | | | | | | |
|---|---|---|---|---|---|---|
| E′ 100 Hz [MPa] | | | | | | |
| −10° C. | 15.3 | 14.2 | 14.6 | 14.7 | 14.5 | 14.9 |
| +23° C. | 8.8 | 8.3 | 8.5 | 8.5 | 8.3 | 8.5 |
| +70° C. | 5.9 | 5.6 | 5.7 | 5.8 | 5.5 | 5.6 |
| Tanδ 100 Hz | | | | | | |
| −10° C. | 0.585 | 0.593 | 0.599 | 0.605 | 0.615 | 0.612 |
| +23° C. | 0.298 | 0.284 | 0.295 | 0.300 | 0.308 | 0.313 |
| +70° C. | 0.188 | 0.164 | 0.173 | 0.176 | 0.185 | 0.193 |

Wear resistance

| | | | | | | |
|---|---|---|---|---|---|---|
| DIN abrasion [mm³] | 58.3 | 69.8 | 64.0 | 58.7 | 52.2 | 58.8 |
| Normalised abrasion [mm³] | 58.3 | 57.7 | 55.9 | 51.8 | 52.9 | 62.9 |

The Mooney viscosity of the compounds of the invention is always higher than the reference, however without consequences on the mixing procedure. The Mooney viscosity tends to rise from the value of the INV1 compound up to a maximum value of the INV3 compound, with a triethylene tetramine content equal to 17%, to then go back down to the value of the INV5 compound, almost equal to that of the INV1 compound.

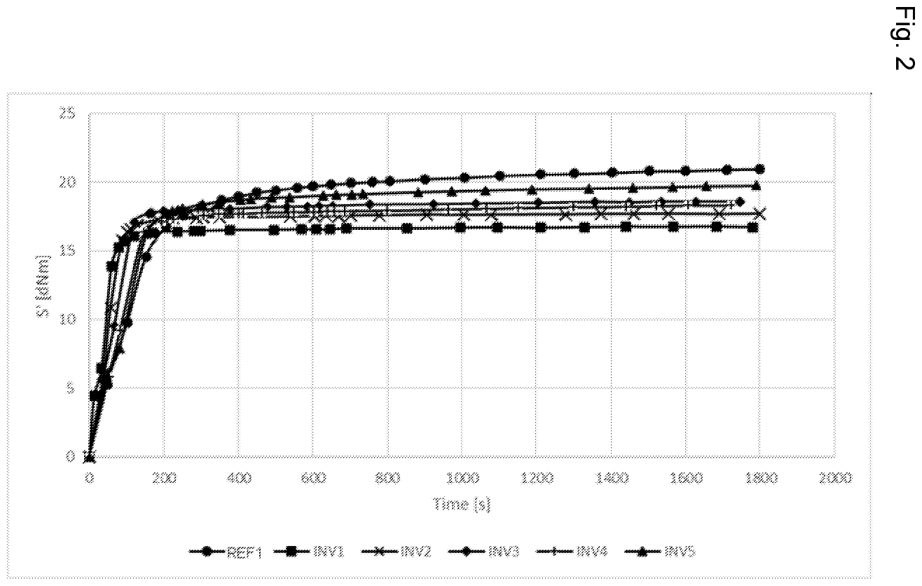

The kinetics of the compounds of the invention is influenced by the presence of triethylenetetramine as may also be observed in the vulcanisation curves of FIG. 2, where it is observed that the compounds of the invention have a faster kinetics than the reference composition, and show a clear flattening of the curve to a constant modulus value, as opposed to the reference composition curve which shows the typical curve with incremental modulus.

The scorch time, as well as the vulcanisation kinetics, is too fast for the INV1 compound comprising the largest amount of triethylenetetramine, but by reducing the amount of triethylenetetramine, both the scorch time and the vulcanisation kinetics reach the desired levels.

The silanisation level reaches almost 100% for both INV1 and INV3 compounds of the invention.

Furthermore, the static mechanical properties increase linearly with the increase in the amount of triethylenetetramine, obtaining values of CA1 and CA3 substantially equal to the reference already with the INV4 compound, and obtaining a higher value of the CA3/CA1 ratio, predictive of better resistance to tearing and dispersion of the white filler, always better than the reference.

Finally, the compounds of the invention show better dynamic mechanical properties than the reference compound with lower hysteresis values at 70° C., predictive of reduced rolling resistance, and equal or slightly higher hysteresis values at 23° C. and at −10° C., predictive of greater adhesion on wet surfaces and at low temperatures.

Abrasion, and above all normalised abrasion, remains at values equal to or slightly better than the reference, with slightly worse values found only for quantities of triethylenetetramine greater than 20% with respect to the quantity of silane coupling agent.

### Example 2

In this example a reference compound was compared with compounds of the invention comprising an increasing amount of triethylenetetramine in addition to the silane coupling agent.

The elastomeric materials listed in the following Table 3 were prepared as follows (the amounts of the various components are indicated in phr).

In the first step, the elastomeric components, the white reinforcing filler, the silane coupling agent, and triethylenetetramine were mixed in an internal mixer (model Pomini PL 1,6) for about 6 minutes up to about 135° C. In the second step, the zinc-based components and the other protectives were added, and the mixing continued for about 4 minutes up to about 135° C. Finally, sulphur and the other vulcanisation additives were added, mixing for a further 2 minutes up to about 95° C., then the vulcanisable elastomeric compound was discharged.

TABLE 3

| COMPOSITION | | | |
|---|---|---|---|
| INGREDIENTS | REF2 | OT1 | OT2 |
| NR | 25 | 25 | 25 |
| BR | 30 | 30 | 30 |
| SSBR | 62 | 62 | 62 |
| Carbon black | 5 | 5 | 5 |
| Silica | 95 | 95 | 95 |
| TESPT | 7.6 | 7.6 | 7.6 |
| TETA | — | 0.65 | 0.33 |
| Stearic acid | 3 | 3 | 3 |
| Wax | 2 | 2 | 2 |
| Resin 1 | 8 | 8 | 8 |
| Resin 2 | 19 | 19 | 19 |
| ZnO | 2.7 | 2.7 | 2.7 |
| 6PPD | 5 | 5 | 5 |
| CBS | 2 | 2 | 2 |
| PVI | 0.3 | 0.3 | 0.3 |
| Sulphur | 0.9 | 0.9 | 0.9 |

NR: Natural Rubber - SIR 20 - Standard Indonesia Rubber
BR: Standard Polybutadiene (High Cis 97%) - SKD NHEODIMIO - (Nizhnekamskneftekhim Export)
SSBR: Styrene butadiene copolymer, extended with 37.5 parts of TDAE oil for every 100 parts of dry polymer - microstructure with 24.9% styrene and 61.7% vinyl on the butadiene fraction - SPRINTAN ™ SLR 4630 - Trinseo
Carbon black: N330 from Cabot Corporation
Silica: Ultrasil ® 7000 - Evonik
TESPT: bis[3-(triethoxysilyl)propyl]tetrasulphide - SI69 ® - Evonik
TETA: Triethylenetetramine -
Wax: RIOWAX BM-01 - Ser SpA
Resin 1: Polybutadiene - Polyvest ® 130 - Evonik
Resin 2: Styrene-butadiene copolymer - Ricon ® 100
ZnO: Standard Zn oxide from A-Esse;
6PPD: N-(1,3-dimethylbutyl)-N′-phenyl-p-phenylene-diamine SANTOFLEX 6PPD from EASTMAN;
CBS: N-cyclohexylbenzothiazole-2-sulphenamide RUBENAMID C EG/C from GENERAL QUIMICA.
Sulphur: Sulphur 98.50% (1% oil) - Zolfindustria

The elastomeric compositions thus prepared above were evaluated for the behaviour in vulcanisation (170° C., 30 min) and subsequently, in terms of static and dynamic mechanical and wear resistance properties according to the methods described above. The following Table 4 shows the rheometric, mechanical, dynamic and static features of the compositions of Table 3.

TABLE 4

| | | |
|---|---|---|
| REF2 | OT1 | OT2 |

Rheometric features

| Mooney ML(1 + 4) 100° C. | | | 66.4 | 61.8 | 61.6 |
|---|---|---|---|---|---|
| Scorch 127° C. | | | 22.4 | 25.2 | 25.3 |
| | ML [dN m] | 30 min | 4.1 | 3.0 | 3.1 |
| | MH [dN m] | 170° C. | 21.7 | 18.2 | 19.9 |
| | TS2 [min] | | 1.0 | 1.0 | 0.9 |
| | T30 [min] | | 1.5 | 1.5 | 1.6 |
| | T60 [min] | | 2.3 | 1.9 | 2.2 |
| | T90 [min] | | 7.7 | 3.7 | 5.6 |

| | | | |
|---|---|---|---|
| Silanisation [% w/w] | 96.7 | — | — |

Static mechanical features

| | | | |
|---|---|---|---|
| Density [g/cm³] | 1.200 | 1.201 | 1.201 |
| Ca1 [MPa] | 1.9 | 2.0 | 2.0 |
| Ca3 [MPa] | 7.1 | 8.5 | 7.9 |
| Ca3/Ca1 | 3.8 | 4.2 | 4.0 |
| CR [MPa] | 14.2 | 14.8 | 13.6 |
| AR [%] | 545.3 | 488.8 | 476.6 |
| IRHD hardness 23° C. | 76.1 | 73.7 | 74.4 |

Dynamic mechanical features

| | | | |
|---|---|---|---|
| E′ 100 Hz [MPa] | | | |
| −10° C. | 15.3 | 14.3 | 14.6 |
| +23° C. | 8.8 | 8.2 | 8.3 |
| +70° C. | 5.9 | 5.6 | 5.6 |
| Tanδ 100 Hz | | | |
| −10° C. | 0.585 | 0.608 | 0.593 |
| +23° C. | 0.298 | 0.297 | 0.296 |
| +70° C. | 0.188 | 0.173 | 0.180 |

Wear resistance

| | | | |
|---|---|---|---|
| DIN abrasion [mm³] | 58.3 | 60.4 | 58.3 |
| Normalised abrasion [mm³] | 58.3 | 50.5 | 52.4 |

The Mooney viscosity decreases slightly by adding the triethylenetetramine while the scorch time increases, inverse behaviour with respect to what was seen in Example 1, where the triethylenetetramine replaced part of the silane coupling agent.

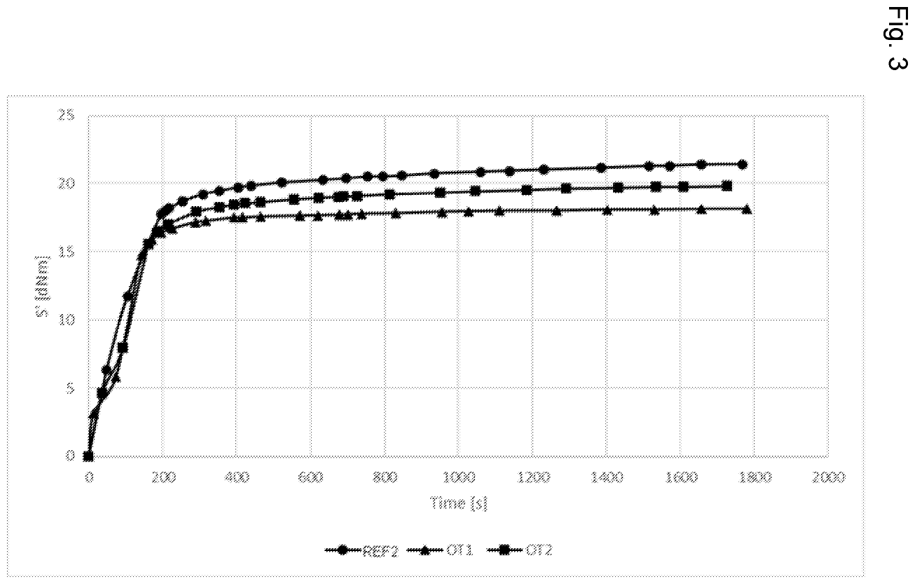

The vulcanisation curve of the compound of the invention OT1, visible in FIG. 3, does not differ much from those seen in Example 1, showing a clear flattening of the curve on a constant modulus value, while the curve of the compound of the invention OT2 showed an incremental modulus similar to that of the curve of the reference compound. Both compounds of the invention had faster kinetics than that of the reference compound.

Furthermore, the static mechanical properties improve considerably already with very low quantities of triethylenetetramine, obtaining higher CA1 and CA3 values already with the OT2 compound, comprising only 4% of triethylenetetramine compared to the quantity of the silane coupling agent, and obtaining a higher value of the CA3/CA1 ratio, predictive of a resistance to tearing, always better than the reference.

Finally, the compounds of the invention show better dynamic mechanical properties than the reference compound with lower hysteresis values at 70° C., predictive of reduced rolling resistance, and equal or slightly higher hysteresis values at 23° C. and at −10° C., predictive of greater adhesion on wet surfaces and at low temperatures.

Abrasion remains substantially the same as the reference value, while the normalised abrasion values showed a clear improvement.

### Example 3

In this example a reference compound (REF BR) containing a different polymeric compound, consisting only of SSBR and BR, was compared with compounds of the invention comprising a quantity of triethylenetetramine in addition to the silane coupling agent (OT BR) and in replacement of a part thereof (INV BR).

The elastomeric materials listed in the following Table 5 were prepared as follows (the amounts of the various components are indicated in phr).

In the first step, the elastomeric components, the white reinforcing filler, the silane coupling agent, and triethylenetetramine were mixed in an internal mixer (model Pomini PL 1,6) for about 6 minutes up to about 135° C. In the second step, the zinc-based components and the other protectives were added, and the mixing continued for about 4 minutes up to about 135° C. Finally, sulphur and the other vulcanisation additives were added, mixing for a further 2 minutes up to about 95° C., then the vulcanisable elastomeric compound was discharged.

TABLE 5

| COMPOSITION | REF | INV | OT |
|---|---|---|---|
| INGREDIENTS | BR | BR | BR |
| BR | 34.5 | 34.5 | 34.5 |
| SSBR | 90 | 90 | 90 |
| Carbon black | 5 | 5 | 5 |
| Silica | 95 | 95 | 95 |
| TESPT | 7.6 | 5.9 | 7.6 |
| TETA | — | 1 | 0.65 |
| Stearic acid | 3 | 3 | 3 |
| Wax | 2 | 2 | 2 |
| Resin 1 | 8 | 8 | 8 |
| Resin 2 | 19 | 19 | 19 |
| ZnO | 2.7 | 2.7 | 2.7 |
| 6PPD | 5 | 5 | 5 |
| CBS | 2 | 2 | 2 |
| PVI | 0.3 | 0.3 | 0.3 |
| Sulphur | 0.9 | 0.9 | 0.9 |

SSBR: Styrene butadiene copolymer, extended with 37.5 parts of TDAE oil for every 100 parts of dry polymer - microstructure with 24.9% styrene and 61.7% vinyl on the butadiene fraction - SPRINTAN ™ SLR 4630 - Trinseo
BR: Standard Polybutadiene (High Cis 97%) - SKD NHEODIMIO - (Nizhnekamskneftekhim Export)
Carbon black: N330 from Cabot Corporation
Silica: Ultrasil ® 7000 - Evonik
TESPT: bis[3-(triethoxysilyl)propyl]tetrasulphide - SI69 ® - Evonik
TETA: Triethylenetetramine -
Wax: RIOWAX BM-01 - Ser SpA
Resin 1: Polybutadiene - Polyvest ® 130 - Evonik
Resin 2: Styrene-butadiene copolymer - Ricon ® 100
ZnO: Standard Zn oxide from A-Esse;
6PPD: N-(1,3-dimethylbutyl)-N′-phenyl-p-phenylene-diamine SANTOFLEX 6PPD from EASTMAN;
CBS: N-cyclohexylbenzothiazole-2-sulphenamide RUBENAMID C EG/C from GENERAL QUIMICA.
Sulphur: Sulphur 98.50% (1% oil) - Zolfindustria

The elastomeric compositions thus prepared above were evaluated for the behaviour in vulcanisation (170° C., 30 min) and subsequently, in terms of static and dynamic mechanical and wear resistance properties according to the methods described above. The following Table 6 shows the rheometric, mechanical, dynamic and static features of the compositions of Table 6.

TABLE 6

| | | |
|---|---|---|
| REF | INV | OT |
| BR | BR | BR |

Rheometric features

| Mooney ML(1 + 4) 100° C. | | | 72.3 | 94.3 | 78.8 |
|---|---|---|---|---|---|
| Scorch 127° C. | | | 20.81 | 12.01 | 21.83 |
| | ML [dN m] | 30 min | 3.8 | 4.9 | 3.8 |
| | MH [dN m] | 170° C. | 20.9 | 19.4 | 19.6 |
| | TS2 [min] | | 1.2 | 0.8 | 1.2 |
| | T30 [min] | | 1.8 | 0.9 | 1.6 |
| | T60 [min] | | 2.6 | 1.2 | 2.2 |
| | T90 [min] | | 6.5 | 2.4 | 3.9 |

Static mechanical features

| | | | |
|---|---|---|---|
| Density [g/cm³] | 1.200 | 1.201 | 1.201 |
| Ca1 [MPa] | 2.4 | 2.3 | 2.5 |
| Ca3 [MPa] | 9.3 | 10.3 | 10.7 |
| Ca3/Ca1 | 3.8 | 4.4 | 4.3 |
| CR [MPa] | 15.5 | 12.3 | 14.0 |
| AR [%] | 482.0 | 368.8 | 397.0 |
| IRHD hardness 23° C. | 75.8 | 71.6 | 73.3 |

Dynamic mechanical features

| | | | |
|---|---|---|---|
| E′ 100 Hz [MPa] | | | |
| −10° C. | 19.7 | 17.1 | 18.4 |
| +23° C. | 10.8 | 9.4 | 10.1 |
| +70° C. | 7.0 | 6.1 | 6.5 |
| Tanδ 100 Hz | | | |
| −10° C. | 0.666 | 0.699 | 0.694 |
| +23° C. | 0.353 | 0.344 | 0.349 |
| +70° C. | 0.198 | 0.180 | 0.184 |

Wear resistance

| | | | |
|---|---|---|---|
| DIN abrasion [mm³] | 65.7 | 58.5 | 60.5 |
| Normalised abrasion [mm³] | 65.7 | 52.6 | 52.6 |

From the tests carried out, an improvement in the vulcanisation kinetics is noted for both the compounds of the invention INV BR and OT BR.

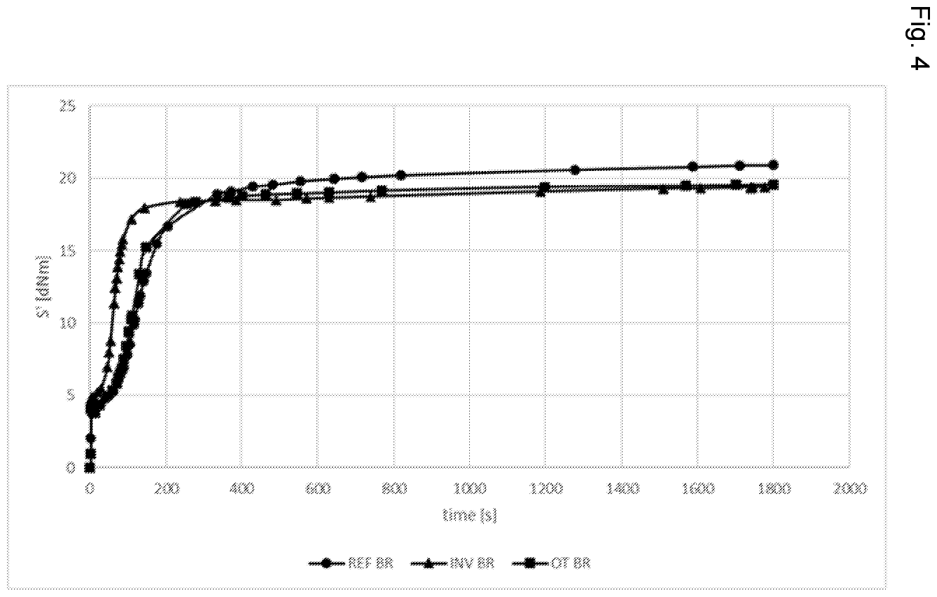

There is an acceleration of the kinetics both from the lower scorch time, which in any case does not reach too low levels, in particular for the INV BR compound, and from the vulcanisation curves (FIG. 4) which also show a flattening on a constant modulus value and faster kinetics in the early stages of vulcanisation, more marked for the INV BR compound.

The static mechanical properties of the compounds of the invention (INV BR and OT BR) show an improvement similar to that seen using triethylene tetramine in compounds with three elastomeric polymers. In fact, higher Ca3 values are obtained in both cases, as well as a higher Ca3/Ca1 ratio, indicative of better resistance to tearing and dispersion of the white filler.

Also in this case, as in the previous examples, there is an improvement in the dynamic mechanical properties.

In the compounds of the invention (INV BR and OT BR) there is in fact an increase in the hysteresis values at low temperatures (−10° C. and 23° C.), indicative of better performance in wet conditions, but at the same time there are lower hysteresis values at high temperatures (70° C.), indicative of lower rolling resistance, and therefore better tyre efficiency from the point of view of fuel consumption.

Finally, the abrasion is reduced already considering the pure loss of mass during the DIN abrasion experiment, with a further improvement if one considers instead the normalised abrasion, which takes into account the greater stiffness, represented by the value of Ca3.

### Example 4

In this example a reference compound (REF NR) containing a different polymeric compound, consisting only of SSBR and NR, was compared with compounds of the invention comprising a quantity of triethylenetetramine in addition to the silane coupling agent (OT NR) and in replacement of a part thereof (INV NR).

The elastomeric materials listed in the following Table 7 were prepared as follows (the amounts of the various components are indicated in phr).

In the first step, the elastomeric components, the white reinforcing filler, the silane coupling agent, and triethylenetetramine were mixed in an internal mixer (model Pomini PL 1,6) for about 6 minutes up to about 135° C. In the second step, the zinc-based components and the other protectives were added, and the mixing continued for about 4 minutes up to about 135° C. Finally, sulphur and the other vulcanisation additives were added, mixing for a further 2 minutes up to about 95° C., then the vulcanisable elastomeric compound was discharged.

TABLE 7

| COMPOSITION | REF | INV | OT |
|---|---|---|---|
| INGREDIENTS | NR | NR | NR |
| NR | 42 | 42 | 42 |
| SSBR | 80 | 80 | 80 |
| Carbon black | 5 | 5 | 5 |
| Silica | 95 | 95 | 95 |
| TESPT | 7.6 | 5.9 | 7.6 |
| TETA | — | 1 | 0.65 |
| Stearic acid | 3 | 3 | 3 |
| Wax | 2 | 2 | 2 |
| Resin 1 | 8 | 8 | 8 |
| Resin 2 | 19 | 19 | 19 |
| ZnO | 2.7 | 2.7 | 2.7 |
| 6PPD | 5 | 5 | 5 |
| CBS | 2 | 2 | 2 |
| PVI | 0.3 | 0.3 | 0.3 |
| Sulphur | 0.9 | 0.9 | 0.9 |

NR: Natural Rubber - SIR 20 - Standard Indonesia Rubber
SSBR: Styrene butadiene copolymer, extended with 37.5 parts of TDAE oil for every 100 parts of dry polymer - microstructure with 24.9% styrene and 61.7% vinyl on the butadiene fraction - SPRINTAN ™ SLR 4630 - Trinseo
Silica: Ultrasil ® 7000 - Evonik
TESPT: bis[3-(triethoxysilyl)propyl]tetrasulphide - SI69 ® - Evonik
TETA: Triethylenetetramine -
Wax: RIOWAX BM-01 - Ser SpA
Resin 1: Polybutadiene - Polyvest ® 130 - Evonik
Resin 2: Styrene-butadiene copolymer - Ricon ® 100
Carbon black: N330 from Cabot Corporation
ZnO: Standard Zn oxide from A-Esse;
6PPD: N-(1,3-dimethylbutyl)-N′-phenyl-p-phenylene-diamine SANTOFLEX 6PPD from EASTMAN;
CBS: N-cyclohexylbenzothiazole-2-sulphenamide RUBENAMID C EG/C from GENERAL QUIMICA.
Sulphur: Sulphur 98.50% (1% oil) - Zolfindustria

The elastomeric compositions thus prepared above were evaluated for the behaviour in vulcanisation (170° C., 30 min) and subsequently, in terms of static and dynamic mechanical and wear resistance properties according to the methods described above. The following Table 8 shows the rheometric, mechanical, dynamic and static features of the compositions of Table 8.

TABLE 8

| | | |
|---|---|---|
| REF | INV | OT |
| NR | NR | NR |

Rheometric features

| Mooney ML(1 + 4) 100° C. | | | 65.6 | 87.5 | 69.5 |
|---|---|---|---|---|---|
| Scorch 127° C. | | | 22.75 | 16.17 | 24.93 |
| | ML [dN m] | 30 min | 3.5 | 4.0 | 3.2 |
| | MH [dN m] | 170° C. | 20.2 | 16.5 | 17.3 |
| | TS2 [min] | | 1.0 | 0.9 | 1.1 |
| | T30 [min] | | 1.6 | 1.1 | 1.5 |
| | T60 [min] | | 2.4 | 1.4 | 2.0 |
| | T90 [min] | | 6.4 | 2.4 | 3.7 |

Static mechanical features

| | | | |
|---|---|---|---|
| Density [g/cm³] | 1.204 | — | 1.205 |
| Ca1 [MPa] | 2.0 | 1.9 | 2.1 |
| Ca3 [MPa] | 8.3 | 8.8 | 9.3 |
| Ca3/Ca1 | 4.1 | 4.6 | 4.5 |
| CR [MPa] | 13.7 | 13.2 | 14.1 |
| AR [%] | 476.3 | 427.8 | 447.5 |
| IRHD hardness 23° C. | 75.0 | 69.1 | 70.8 |

Dynamic mechanical features

| | | | |
|---|---|---|---|
| E′ 100 Hz [MPa] | | | |
| +23° C. | 9.6 | 9.0 | 9.4 |
| +70° C. | 5.7 | 5.3 | 5.6 |
| Tanδ 100 Hz | | | |
| +23° C. | 0.399 | 0.408 | 0.396 |
| +70° C. | 0.192 | 0.186 | 0.180 |

Wear resistance

| | | | |
|---|---|---|---|
| DIN abrasion [mm³] | 107.2 | 113.7 | 113.1 |
| Normalised abrasion [mm³] | 107.2 | 107.1 | 100.9 |

Also in this case, the tests carried out show an improvement in the vulcanisation kinetics for both the compounds of the invention INV NR and OT NR.

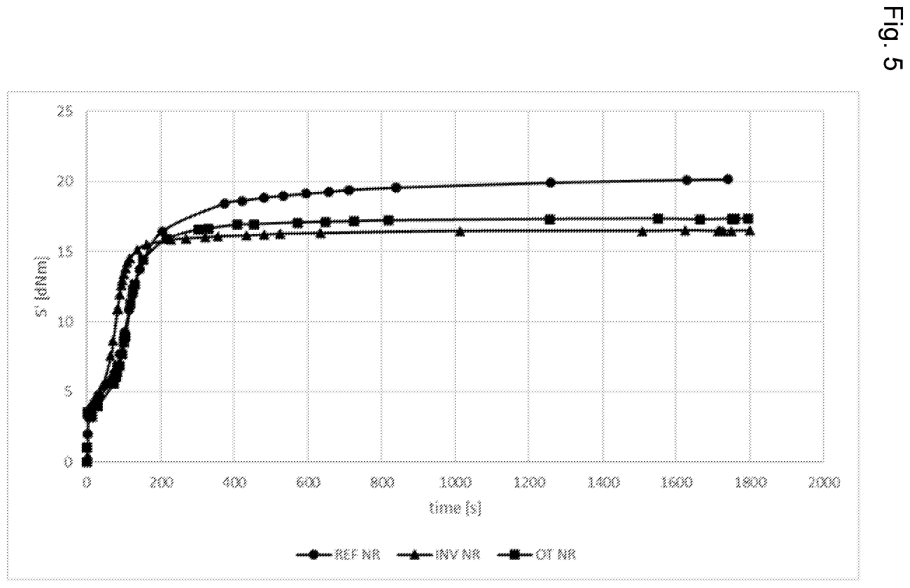

There is an acceleration of the kinetics both from the lower scorch time, which in any case does not reach too low levels, in particular for the INV NR compound, and from the vulcanisation curves (FIG. 5) which also show a flattening on a constant modulus value and faster kinetics in the early stages of vulcanisation, more marked for the INV NR compound.

The static mechanical properties of the compounds of the invention INV NR and OT NR show an improvement similar to that seen using triethylene tetramine in compounds with three polymers. In fact, higher Ca3 values are obtained in both cases, as well as a higher Ca3/Ca1 ratio, indicative of better resistance to tearing and dispersion of the white filler.

Also in this case, as in the previous examples, there is an improvement also in the dynamic mechanical properties.

In the compounds of the invention (INV NR and OT NR) hysteresis values at low temperatures (23° C.) are higher or in line with the reference, indicative of good performance in wet conditions, but at the same time there are lower hysteresis values at high temperatures (70° C.), indicative of lower rolling resistance, and therefore better tyre efficiency from the point of view of fuel consumption.

Finally, the abrasion is almost in line with the reference, with a slight improvement in particular for the normalised abrasion of the OT NR compound.

1. A tyre comprising at least one structural element including a vulcanised elastomeric material,
the vulcanised elastomeric material comprising, before vulcanisation, a vulcanisable elastomeric compound,
the vulcanisable elastomeric compound comprising, before mixing, an elastomeric composition comprising per 100 phr of diene elastomeric polymer:
(a) 30 to 95 phr of at least one styrene-butadiene polymer (SBR);
(b) 5 to 70 phr of at least one diene elastomeric polymer selected from the group consisting of at least one isoprene polymer (IR), at least one butadiene polymer (BR), and mixtures thereof;
(c) 10 phr to about 120 phr of at least one white reinforcing filler;
(d) from about 1% to about 20% by weight, relative to the amount of said white reinforcing filler, of at least one silane coupling agent;
(e) 1% to 35% by weight relative to the amount of said silane coupling agent, of a polyamine.

2. The tyre according to claim 1, wherein said elastomeric composition comprises, per 100 phr of diene elastomeric polymer:
(a) 40 to 70 phr of at least one styrene-butadiene polymer (SBR);
(b) 10 to 40 phr of at least one isoprene polymer (IR); and
(c) 20 to 50 phr of at least one butadiene polymer (BR).

3. The tyre according to claim 1, wherein said elastomeric composition comprises, per 100 phr of diene elastomeric polymer:
(a) 50 to 80 phr of at least one styrene-butadiene polymer (SBR); and
(b) 20 to 50 phr of at least one butadiene polymer (BR).

4. The tyre according to claim 1, wherein said elastomeric composition comprises, per 100 phr of diene elastomeric polymer:
(a) 50 to 80 phr of at least one styrene-butadiene polymer (SBR); and
(b) 20 to 50 phr of at least one isoprene polymer (IR).

5. The tyre according to claim 1, where said polyamine is represented by the following formula (IV): 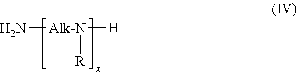
where x is an integer from 2 to 6, R is a hydrogen atom or alkyl group having 1 to 3 carbon atoms, and Alk is a divalent linear-chain alkylene group having 1 to 8 carbon atoms.

6. The tyre according to claim 1, where said polyamine is selected from the group consisting of diethylene triamine, triethylene tetraamine, tetraethylene pentamine, pentaethylene hexamine, heptaethylene octamine, dipropylene triamine, tripropylene tetraamine, tetrapropylene pentamine, dibutylene triamine, tributylene tetraamine, tetrabutylene pentamine, dimethylene triamine, trimethylene tetraamine, tetramethylene pentamine, pentamethylene hexamine, di (heptamethylene) triamine, di (trimethylene) triamine, decaethylene endecamine, decamethylene endecamine, N,N-dimethyl diethylene triamine, N,N-dimethyl tetraethylene pentamine, N,N-diethyl tetraethylene pentamine, N,N′,N″-trimethyldiethylene triamine, dipentylene triamine, triesylene tetraamine, tetraheptylene pentamine, trioctylene tetraamine, and tetrapentylene pentamine.

7. The tyre according to claim 1, where said polyamine is selected from the group consisting of trimethylene tetraamine, triethylene tetraamine, and tripropylene tetraamine.

8. The tyre according to claim 1, wherein said tyre further comprises:
a carcass structure, having opposite side edges associated with respective left and right bead structures;
a tread band applied in a radially external position relative to said carcass structure;
a pair of sidewalls laterally applied on opposite sides to said carcass structure; and
wherein said structural element is at least one of said tread band or said pair of sidewalls.

9. An elastomeric composition comprising per 100 phr of diene elastomeric polymer:
(a) 30 to 95 phr of at least one styrene-butadiene polymer (SBR);
(b) 5 to 70 phr of at least one diene elastomeric polymer selected from the group consisting of at least one isoprene polymer (IR), at least one butadiene polymer (BR), and mixtures thereof;
(c) 10 phr to about 120 phr of at least one white reinforcing filler;
(d) from about 1% to about 20% by weight, relative to the amount of said white reinforcing filler, of at least one silane coupling agent;
(e) 1% to 35% by weight relative to the amount of said silane coupling agent, of a polyamine.

10. The elastomeric composition according to claim 9, where said composition comprises per 100 phr of diene elastomeric polymer:
(a) 40 to 70 phr of at least one styrene-butadiene polymer (SBR);
(b) 10 to 40 phr of at least one isoprene polymer (IR); and
(c) 20 to 50 phr of at least one butadiene polymer (BR).

11. The elastomeric composition according to claim 9, wherein said composition comprises per 100 phr of diene elastomeric polymer:
(a) 50 to 80 phr of at least one styrene-butadiene polymer (SBR); and
(b) 20 to 50 phr of at least one butadiene polymer (BR).

12. The elastomeric composition according to claim 9, wherein said composition comprises per 100 phr of diene elastomeric polymer:
(a) 50 to 80 phr of at least one styrene-butadiene polymer (SBR); and
(b) 20 to 50 phr of at least one isoprene polymer (IR).

13. The elastomeric composition according to claim 9, wherein said polyamine is represented by the following formula (IV): 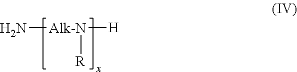
where x is an integer from 2 to 6, R is a hydrogen atom or alkyl group having 1 to 3 carbon atoms, and Alk is a divalent linear-chain alkylene group having 1 to 8 carbon atoms.

14. The elastomeric composition according to claim 9, wherein said polyamine is selected from the group consisting of diethylene triamine, triethylene tetraamine, tetraethylene pentamine, pentaethylene hexamine, heptaethylene octamine, dipropylene triamine, tripropylene tetraamine, tetrapropylene pentamine, dibutylene triamine, tributylene tetraamine, tetrabutylene pentamine, dimethylene triamine, trimethylene tetraamine, tetramethylene pentamine, pentamethylene hexamine, di (heptamethylene) triamine, di (trimethylene) triamine, decaethylene endecamine, decamethylene endecamine, N,N-dimethyl diethylene triamine, N,N-dimethyl tetraethylene pentamine, N,N-diethyl tetraethylene pentamine, N,N′,N″-trimethyldiethylene triamine, dipentylene triamine, triesylene tetraamine, tetraheptylene pentamine, trioctylene tetraamine, and tetrapentylene pentamine.

15. The elastomeric composition according to claim 9, wherein, where said polyamine is selected from the group consisting of trimethylene tetraamine, triethylene tetraamine, and tripropylene tetraamine.

16. The elastomeric composition according to claim 9, wherein, said polyamine is triethylene tetraamine.

17. The elastomeric composition according to claim 9, wherein said elastomeric composition comprises, per 100 phr of diene elastomeric polymer, (c) 20 phr to 100 phr, of at least one white reinforcing filler.

18. The elastomeric composition according to claim 9, wherein said elastomeric composition comprises, per 100 phr of diene elastomeric polymer, (e) 5% to 25% by weight, relative to the amount of said silane coupling agent, of a polyamine.

19. The tyre according to claim 1, wherein said elastomeric composition comprises, per 100 phr of diene elastomeric polymer, (c) 20 phr to 100 phr, of at least one white reinforcing filler;

20. The tyre according to claim 1, wherein said elastomeric composition comprises, per 100 phr of diene elastomeric polymer, (e) 5% to 25% by weight, relative to the amount of said silane coupling agent, of a polyamine.

21. The tyre according to claim 1, wherein said polyamine is triethylene tetraamine.
